(19) United States
(12) Patent Application Publication
(10) Pub. No.: US 2015/0128147 A1
(43) Pub. Date: May 7, 2015

(54) MODIFIED JVM WITH MULTI-TENANT APPLICATION DOMAINS AND MEMORY MANAGEMENT

(71) Applicant: Waratek Limited, Milsons Point (AU)

(72) Inventor: John Matthew Holt, Dublin 2 (IE)

(73) Assignee: Waratek Limited a corporation

(21) Appl. No.: 14/397,584

(22) PCT Filed: Apr. 30, 2013
(86) PCT No.: PCT/AU2013/000434

§ 371 Date: Oct. 28, 2014

(30) Foreign Application Priority Data
Apr. 30, 2012 (AU) 2012901752

(51) Int. Cl. G06F 9/50; G06F 12/02

(52) U.S. Cl. CPC G06F 9/5016; G06F 12/0253; G06F 2212/702
USPC 718/104

(57) ABSTRACT

A method and system for operating a modified JAVA Virtual Machine (JVM) which is able to simultaneously host multiple JAVA application programs, are disclosed. The JVM is modified to maintain a computer record of one or more application domains, each having one or more classes. For each application domain a first utilization count of the total memory volume in bytes occupied by all allocated instances of the application class, is maintained. Preferably this count is incremented with each new instance of an application class, and decremented during or alter each garbage collection event which reclaims allocated application classes

### FIELD OF THE INVENTION

The present invention relates to the operation of services which host multiple application programs.

### BACKGROUND ART

The prior art relevant to the present invention will now be described with reference to the accompanying drawings in which:

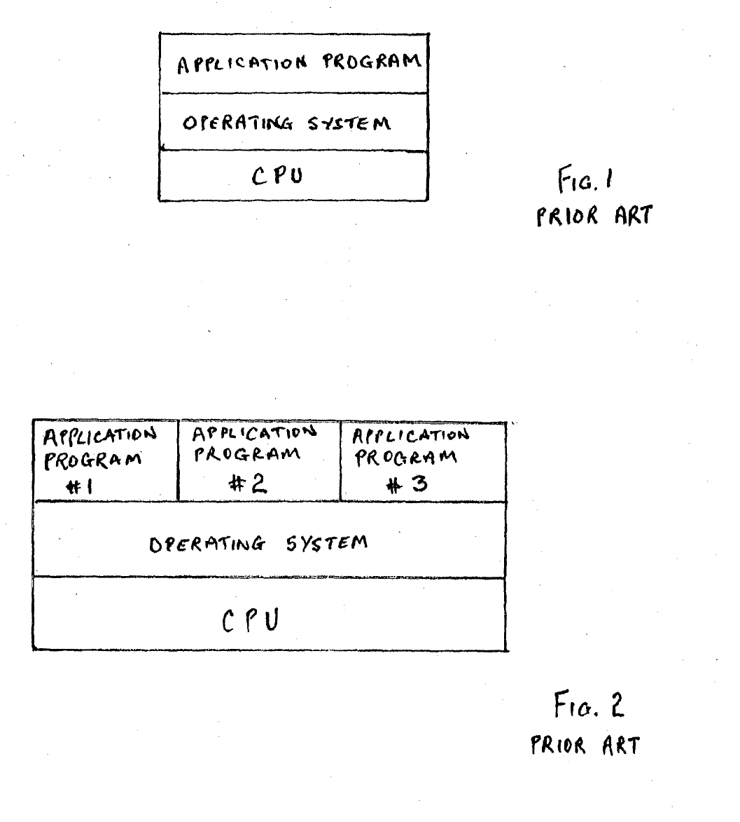

FIG. 1 is schematic diagram showing the operation of a conventional computer with a single CPU,

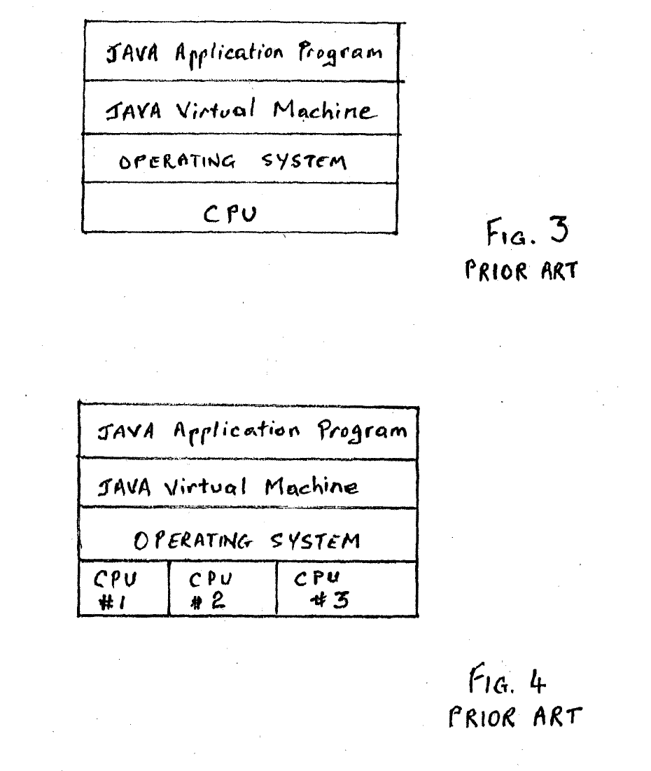

FIG. 2 is a schematic diagram showing the operation of multiple application programs on a single CPU,

FIG. 3 is a schematic diagram of an application virtual machine such as a JVM,

FIG. 4 is a schematic diagram of a server computer with multiple CPUs operating a single JVM and a single application program,

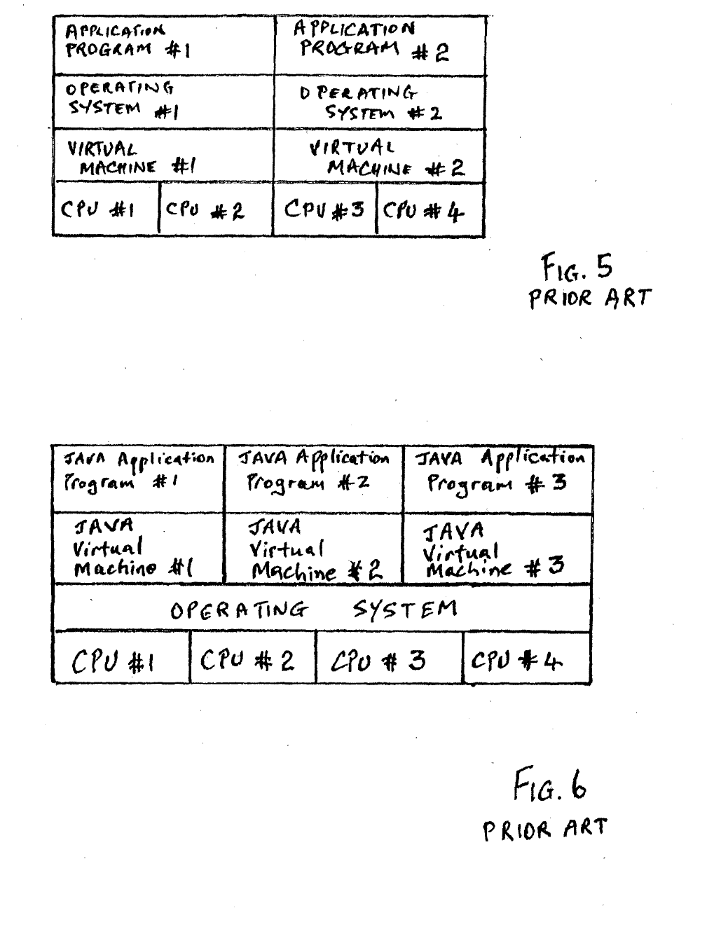

FIG. 5 is a schematic diagram of a server computer with multiple CPUs operating multiple JVMs each with a single application program

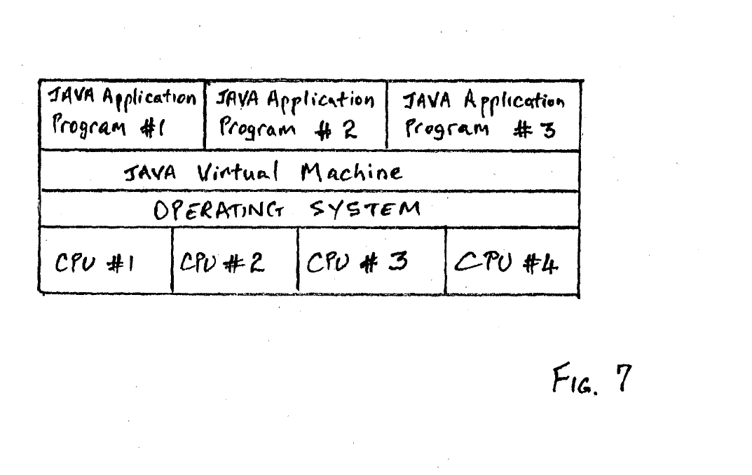

FIG. 6 is a schematic diagram of a server computer with multiple CPUs operating multiple JVMs and a single operating system, and

FIG. 7 is a schematic diagram of a proposed server computer with multiple CPUs operating a single JVM and a single operating system but multiple application programs.

### DETAILED DESCRIPTION

Modified JVM with multi-tenant application domains and memory management A conventional computer has a central processing unit (CPU) which is managed by an operating system which is not apparent to the user of the computer. An application program runs on the computer utilising both the operating system and the CPU. This conventional arrangement is illustrated in FIG. 1 and has been in operation for many years.

It is known to run several application programs on a single conventional computer by means of operating each application program successively for a short period. This is equivalent to a time divisional multiplex procedure and is illustrated in FIG. 2.

It has also been known for many years to operate an “application virtual machine” (see http://en.wikipedia.org/wiki/Application_virtual_machine#Process_virtual_machines) in which the application program is written in a language (eg. JAVA) which is itself incompatible with the operating system and/or CPU on which it is to be run.

However, an application virtual machine such as a JAVA Virtual Machine (JVM) sits between the operating system and the application program. Thus as far as the user of the application program is concerned, the computer operates in the JAVA language even though the CPU and the operating system do not use JAVA. This arrangement is illustrated in FIG. 3.

Some computers are designed specifically for hosting server applications like Database Management Systems (e.g. MySQL) and Web Server applications (like Apache Httpd), and these computers, called server computers, are designed with more than one CPU in order to operate the hosted application program(s) faster than is possible with a single CPU. Various plural CPU designs are known in the industry for operating multiple CPUs within a single server computer. Recent server computer designs incorporate ‘nested’ CPU configurations where one larger CPU device (microchip) comprises multiple built-in smaller CPUs called ‘CPU cores’. Regardless of which multiple CPU arrangement is employed, each CPU or CPU core is available to the operating system software. FIG. 4 shows such a server computer configuration with multiple CPUs operating a single JVM and single Java application program. In the late 1990's server virtualization arose as a means to address the phenomena of low server utilization rates that had arisen from a “one-application-program-per-server” model of the years prior. Server virtualization, such as provided by VMWare ESX and Citrix XenServer products today, made it possible to operate multiple independent operating systems on a single physical server, thereby increasing server utilization rates from the typical levels of 15% to far higher levels. This is illustrated in FIG. 5. The approach of multi-hosting several application programs on a single physical server using server virtualization techniques was termed “server consolidation”, and proved successful in increasing server utilization rates for a number of application and workload cases. Server consolidation for legacy applications such as Database Management Systems (such as MySQL) and WebServer (such as Apache Httpd) applications has proven effective at increasing server utilization rates and reducing server infrastructure costs for these applications.

However, recently with this stratagem it has been recognized that Java language applications do not enjoy the same efficiency increases as applications written in other languages (e.g C, C++) when deployed on a shared server infrastructure. The reasons for this stem from the original design of the Java Platform, which imposed restrictions and limitations to efficiently hosting multiple Java applications an a single physical server environment.

The problem of hosting Java applications efficiently on shared server infrastructure has become further compounded by the rapid adoption of cloud computing environments as an application hosting option. Here, many independent Java applications from independent and mutually-distrusting customers are sought to be hosted by cloud computing vendors on shared physical server infrastructure. This is illustrated in FIG. 6. In this connection the teen “distrusting” refers to the customer's desire to operate their application program in an isolated and secure environment from other unknown and potentially malicious application programs. Naturally, the cloud hosting vendor wishes to achieve as close to 100% server utilization as possible in order to increase the return on the purchased server infrastructure investment. In these cloud computing environments unused server capacity, whether it be unused CPU cycles or unused bytes of memory, represents a financial loss for the hosting provider as they do not earning revenue on these idle resources.

The inefficiencies of Java language application programs within shared server environments, and more recently in cloud computing environments, has been identified as a significant problem area for hosting providers seeking to achieve near 100% server utilization for their hosted workloads. The reasons for Java's inefficiencies stem from the design and nature of the Java Platform and the fundamentals of how modern Java Virtual Machines operate today. For example, The Java Platform includes within its design the use of “garbage” collection techniques for automating memory management of Java application programs by the deletion of memory records, classes, fields, objects, etc. which are no longer required for the operation of the application program. Garbage collection, however, places a considerable burden on the Java Virtual Machines that host Java applications, as inefficient garbage collection algorithms may significantly reduce the performance and usability of Java applications due to frequent disruptions to application execution and long pause times when garbage collection procedures are operating.

In an attempt to reduce the garbage collection overhead for Java applications, modern JVMs incorporate sophisticated garbage collection techniques based on parallel and concurrent collection algorithms which reduce pause-times and disruptions to executing Java applications. However, these contemporary parallel and concurrent garbage collection algorithms achieve this improvement through considerable consumption of CPU and memory resources of the underlying physical server.

For example, in modern concurrent garbage collection algorithms such as the “garbage first” algorithm, the JVM allocates at least one garbage collector thread to each physical CPU core available to the underlying operating system, pinning (or locking) each collector thread to a designated CPU (or CPU core) and then operating these threads concurrently with application execution. As a result, even when the Java application is itself idle, the JVM using a “garbage first” collector algorithm will have allocated enough threads to occupy all of the CPU cores available to the underlying operating system and will execute these collector threads concurrently in the background on all of the available CPU cores.

So long as only one JVM is operated at a time per operating system, then the JVM and the Java application are able to perform consistently at their peak possible performance. However, as is frequently the case with enterprise applications which experience periods of low computational load (such as may be experienced outside of business hours), cloud computing vendors and others who seek to host Java applications wish to be able to load multiple Java applications on shared physical server infrastructure. The inefficiencies of hosting Java applications on shared server infrastructure and cloud computing environments arises therefore when multiple independent Java applications running in multiple independent JVMs are attempted to be hosted on a single shared physical server and operating system.

For example, after starting the first JVM on a shared operating system, that JVM will typically allocate one garbage collector thread to each CPU core available to the operating system, and using contemporary garbage collection algorithms, will operate these threads on each CPU core concurrently with application execution. When a second JVM is then attempted to be started on the same physical server and operating system environment, problems begin to arise. As the second JVM starts it will, like the first JVM, allocate one garbage collector thread to each CPU core available to the underlying operating system. However, the first JVM has already done exactly the same thing. Therefore the situation is created where the two JVMs each have allocated enough threads to consume the available CPU cores. That is, each core has one garbage collector thread allocated to it from each JVM, but each JVM believes it has controlling use of that CPU core (which it not the case). Obviously as more simultaneous JVMs are started beyond two, this problem is proportionally compounded. Problematic behaviour will begin to be observed therefore when the two or more JVMs begin performing garbage collection activities at the same time, as each JVM will compete with the other JVM (or other JVMs) to perform its background garbage collection duties on each CPU core. This creates a significant contention point on each CPU core caused by each JVM's threads competing with each other JVM's threads to perform their respective garbage collection and other Java Platform management duties, resulting in substantial CPU and memory load together with an all too apparent slow performance of the hosted Java applications.

### GENESIS OF THE INVENTION

Thus this situation has led to the recognition that hosting plural Java applications on shared server infrastructure and cloud computing environments is significantly inefficient. The Genesis of the present invention is a desire to conceive of a more efficient mechanism for hosting Java applications on shared server infrastructure and cloud computing environments.

### DETAILED ANALYSIS OF THE PRIOR ART

A number of approaches have been proposed for hosting multiple Java applications on shared server infrastructure more efficiently, by hosting these multiple applications within a single shared JVM. An illustration of such a desirable arrangement as this is shown in FIG. 7. If this were possible, then the inefficiencies of hosting multiple Java applications on a shared server infrastructure or cloud computing environment would be at least partially resolved. This is because a single JVM could be started for a given physical server and/or operating system and then multiple Java applications could be hosted within that single JVM. In this way, the single JVM could employ the latest parallel and concurrent garbage collection algorithms without concern about contention or competition with other JVM instances operating on the same shared operating system or physical server, as it would be the only JVM on that operating system/server device and could execute its garbage collection algorithms without interference from other competing JVMs.

Unfortunately, however, the Java Platform, comprising the Java Virtual Machine Specification, the Java Language Specification, and the Java Application Programming Interface (API) Specification, never contemplated hosting multiple independent standalone applications within a single shared JVM. When the Java Platform specifications were designed, the architects anticipated a one-application-per-JVM model, and the relevant specifications were defined accordingly.

For example, one of the Java API classes defined by the Java Platform specifications is the java.lang.System class. The java.lang.System class contains three publically-accessible field variables—namely in, out, and err, which may be set via the setIn( ), setOut( ), and setErr( ) methods respectively. The Java Platform specifications specify that only a single java.lang.System class may be loaded and defined per JVM, and therefore that only a single occurrence of these three field variables may exist per JVM. This creates a significant problem then when two applications are attempted to be operated within the same JVM at once, as each application will assume it controls the setup of the System.out/err/in field variables for its own use via the setIn( ), setOut( ), and setErr( ) functions. As the Java Platform specification restricts these field variables to only having one unique value each, only one of two (or more) Java applications attempting to operate concurrently within a single JVM will be able to control these singleton field variables for all applications; the other applications will be forced to use the in/out/err fields of the last controlling application that set them. This will potentially result in undefined and erroneous behaviour for all applications, not merely one of the applications.

The java.lang.System class is only one example of many restrictions and limitations inherent in the Java Platform specifications that frustrate attempts to co-host multiple independent application programs within a single shared JVM in a safe and secure manner. Another significant example of where the Java Platform specifications frustrate attempts to devise a multi-tenancy framework for the Java Platform is around the challenges of memory accounting and memory partitioning of JVM heap memory between co-hosted applications.

Existing server virtualization products for non-Java application programs like VMware ESX and Citrix XenServer provide extensive memory accounting and memory partitioning features between multiple virtual machines operating on a single shared physical server. These memory accounting and control features are used to partition available system memory between the co-hosted applications in a safe and secure manner, and enforce policies that ensure one application program can not consume or interfere with the memory of another neighbouring application program.

In the Java Platform specifications however, no means of intra-heap memory accounting or memory partitioning between application classes is provided for. As a result, any application class loaded within a single prior-art JVM is able to consume without moderation, whether intentionally or unintentionally, JVM heap memory shared with other application classes, potentially resulting in memory starvation for one or more other application classes (whether or not those other application classes are part of the same application or not).

Right throughout the Java Platform specifications there are limitations and restrictions which make it impractical for existing JVMs following the Java Platform specifications to host multiple applications wholly independently and simultaneously, without risking erroneous operation or security violations for one or all of the co-hosted applications. Nonetheless various strategies have been so far proposed to support co-hosted applications within a single shared JVM, however none of these prior approaches address the memory accounting and memory partitioning challenges faced in co-hosting multiple Java applications within a single shared JVM.

One such prior art attempt to host multiple applications within a single JVM involves defining a restricted subset of the Java Platform specifications which is permitted for use in a multi-hosted configuration, and disallowing all other non-permitted operations and features of the Java Platform specifications which are not safe or secure for multi-tenant operation (for example that are not safe or secure when there are multiple independent application programs being hosted simultaneously). One example of this prior art approach is Google's AppEngine for Java, where a proprietary “JRE White List” is defined informing programmers and application developers what parts of the Java Platform specifications they are permitted to use on Google's AppEngine system, and which parts they are not permitted to use (see https://developers.google.com/appengine/docs/java/jrewhitelist). JRE stands for Java Runtime Environment. So long as application programmers restrict themselves to this reduced feature list, then Google AppEngine will be able to deploy their application in a multi-tenant JVM environment operated by Google. While Google AppEngine provides various mechanisms for controlling a hosted application's use of files, sockets, threads and so on, no memory accounting or memory control features are provided for controlling the use of shared JVM heap memory between co-hosted applications. As a result a malicious (or incompetent) application program operating on the Google AppEngine system can potentially consume all of the available shared JVM heap memory, and as a consequence starve other co-hosted application programs within the same shared JVM from accessing enough JVM heap memory for their operation.

Another attempt at a multi-tenant framework for the Java Platform is defined in the specification of U.S. Pat. No. 6,931,544 (Kienhoefer/The SCO Group, Inc) where extensive use of a security manager facility like the java.lang.SecurityManager class defined by the Java Platform specifications, is used to apply differing permissions and privileges to co-hosted applications operating within a single JVM. The description of the co-hosting technique of the U.S. Pat. No. 6,931,544 is explicitly directed for use with unmodified JVMs such as those JVMs provided by Sun Microsystems (now Oracle) and others (see column 3, line 56-59, and column 4, line 4-9 of the patent specification). U.S. Pat. No. 6,931,544 eschews modifying the underlying JVM or Java Platform specifications in favour of attempting to retrofit co-hosting support on top of existing unmodified JVMs and unmodified Java API classes. While several simple control mechanisms are described for moderating a co-hosted application's use of files, sockets, and threads, no accounting or control methods are disclosed for moderating a co-hosted application's use of shared JVM heap memory in order to ensure safe and secure operation of concurrently executing application programs.

Unlike programming languages like the C and C++ programming languages, the Java programming language provides an automatic memory management system within the JVM, which controls all aspects of memory allocation and reclamation on behalf of the application program. The JVM defines a “Java heap memory” space where all Java objects are loaded and tracked by the JVM using the garbage collection services built into the JVM. As a result, application programs written in the Java programming language are able to let the duties of memory reclamation be performed by the JVM on their behalf, without requiring manual memory management like application programs written in the C and C++ languages.

In designing a multi-tenancy framework for the Java Platform, it is necessary to not only address the challenges of application compatibility and basic functional control, but also to provide controls over how shared JVM heap memory is allocated and consumed be each of the concurrently hosted application programs operating on that single shared JVM. Unfortunately however, neither of the above two prior art approaches address any of the memory accounting and memory partitioning challenges of hosting multiple independent application programs within a single shared JVM in a safe and secure manner. The present invention discloses an arrangement that substantially overcomes the restrictions and security vulnerabilities of these previous approaches.

The use of the terms “Java API classes” and “Java API class” are to be understood to mean either classes (such as java.lang.Object) defined by the Java Platform specifications, or classes defined as part of the java.* package namespace such as for example java.lang.Thread, java.io.File, and java.io.FileSystem.

The use of the term “class definition” is to be understand to mean a class type represented by a unique java.lang.Class instance, such as may be created by java.lang.ClassLoader.defineClass(String name, byte[ ] buffer, int offset, int length) and related methods, or by a bootstrap class loader. More than one class definition may be loaded for an identically named class (e.g. org.example.ClassA), resulting in multiple unique java.lang.Class instances, one for each class definition. Two class definitions which share the same name (for example as reported by the java.lang.Class.getName( ) method) are unique and not the same class definition if their respective java.lang.Class references are not equal, such as may be determined through the Java operations “org.example.ClassA.class !=org.example.ClassA.class” or “new org.example.ClassA( ).getClass( ) !=new org.example.ClassA( ).getClass( )” or “instanceOneOfClassA.equals(instanceTwoOfClassA)==false”. Different class definitions with the same name are not required to be identical, or be defined with identical bytecode, or have the same number and composition of methods, fields, and constructors.

The use of the term “bootstrap class loader” is to be understood to mean either a bootstrap class loader as described within the Java Platform specifications, or any other class loader where some or all of the classes defined by that class loader return “null” to the java.lang.Class.getClassLoader( ) method of the said classes.

The use of the term “application class loader” is to be understood to mean either a user-defined class loader as described within the Java Platform specification, or any class loader where some or all of the classes defined by that class loader do not return “null” to the java.lang.Class.getClassLoader( ) method of the said classes.

The use of the term “JVM” herein is to be understood to mean a Java Virtual Machine comprising an implementation of the Java Virtual Machine Specification and related set of Java API classes. In some JVMs, the Java API classes may be separately developed or maintained and only linked with the JVM at operating time (runtime). For the purposes of this specification, it is to be understood that the term “JVM” is inclusive of such runtime-linked Java API classes, regardless of whether some or all of these Java API classes are maintained separately from the rest of the JVM.

Examples of existing JVMs include the OpenJDK JVM, the Oracle HotSpot JVM, the Oracle JRocket JVM, the IBM J9 JVM, the JikesRVM, the Maxine JVM, and the Waratek DRLVM.

### SUMMARY OF THE DISCLOSURE

A modified JVM is described which is able to simultaneously operate multiple independent Java applications within a single executing JVM instance in a safe and secure manner. The modified JVM arrangement taught in the present specification improves the memory allocation and reclamation functions of prior art JVMs, with the ability to measure memory consumption of individual application programs co-hosted within a single shared JVM. This is achieved through a number of modifications to the JVM described below.

By a first modification, a JVM is modified to maintain a record of each concurrently hosted application program within that single JVM. For each application being hosted within the JVM, an application program record is maintained in computer memory for one or more application classes comprising that application program, and a set of statistical values of the operation of the application classes is maintained within that application program record.

It is necessary to maintain such an application program record and statistical values in order that modified memory accounting procedures will be able to correctly account for consumed memory capacity of an application program. This application program record may take several forms, such as a listing, a tabulation, or a struct. Appendix A shows such a struct form where several count values are indicated.

It is necessary that for each application program record, at least one statistical count value of the memory capacity occupied by the objects allocated by the application classes of an application program is provided. Such a count value may take several forms, such as a count in bytes of the total memory consumed by the objects allocated by the application classes related to that application program record. Also several unique count values can be maintained for a given application program record, such as Appendix A shows. For example it is desirable that one statistical count value is maintained for the total size in bytes of all Objects allocated by application classes over a given time period, while a second statistical count value is maintained for the total size in bytes of all Objects reclaimed (or deleted) over the same time period which were allocated by application classes belonging to the given application program record. When a plural count value arrangement such as this is used, a correct indication of consumed JVM heap memory of a given application program can be determined by a calculation comparing the relevant count values such as by subtracting the second count value from the first count value. Other arrangements of plural count values are possible.

A second modification is also made to provide a lookup procedure or function for looking up the application program record to which an application class belongs. This is able to be achieved in one of several possible arrangements. In a first arrangement, the internal class representation of each application class (such as the unique java.lang.Class instance representing that application class) is modified to include a field or variable value identifying the application program record to which that application class belongs. In a second arrangement, a master list, such as a hashtable or similar datastructure, is provided for relating application classes (such as the unique java.lang.Class references of each application class) to the application class records to which they belong.

By a third modification the memory allocation function(s) of the JVM are modified to update the count value (or values) of an application program record with the size of the new object attempting to be allocated by an application class. The memory allocation functions of a JVM can take several forms. The memory allocation function can take the form of a procedure call similar to the malloc( ) function of various operating systems, where the invoker of the memory allocation function is an application class attempting to construct a new object by means of a NEW instruction within the method bytecode of that class. Appendix B shows such an excerpt of method bytecode of an application class in a disassembled instruction sequence form as produced by the javap tool, where NEW instruction 23 represents a memory allocation instruction of that application class. Depending on the particular JVM, the NEW instruction may be implemented in several ways. In one form the NEW instruction can be transformed by means of a just-in-time compiler into a function call to a JVM function to allocate the memory that will comprise the newly allocated object. In another form the NEW instruction may be interpreted by a hardware processor or an instruction interpreter implemented in software, to allocate the memory that will comprise the newly allocated object. Typically the size of the new object to be allocated can be determined from the information stored in the Class reference or representation passed as a parameter to the NEW instruction. Other forms of memory allocation functions will be known to those skilled in the computing arts.

In one arrangement, the JVM's memory allocation procedures are modified, such as by a just-in-time compiler, to pass a parameter at invocation which identifies the application program record of the application class invoking the memory allocation procedure, and to update the count value of the so-identified application program record with the size of the new object being allocated. Such a parameter can take the form of a unique integer value identifying the application program record, or a pointer or memory address value of the application program record in computer memory.

In another arrangement, the memory allocation procedures are modified to identify the application class invoking the allocation procedure utilising a lookup procedure provided for that purpose, and updating the count value of the application program record related to the application class invoking the memory allocation function with the size of the new object being allocated.

In yet another arrangement, the memory allocation procedures are modified to read a thread local storage value identifying the application program record of an application class, and updating the count value of the application program record so identified with the size of the new object being allocated.

Regardless of the precise arrangement employed, the memory allocation functions of the JVM are modified to achieve the effect that upon invocation of such functions by an application class, the memory allocation functions can (i) identify the application program record of the application class which invoked the memory allocation function, and (ii) add the memory size in bytes of the new object being allocated to a count value maintained in the application program record for that purpose.

Without modifying the memory reclamation (or deletion) functions, the count value of an application program record indicating memory consumption of the related application classes would appear to constantly increase, without ever decreasing to reflect the memory reclaimed by the garbage collection functions of the JVM. Therefore, by a fourth modification, the memory reclamation functions of the JVM are modified to update the count values of the application program records to reflect the reclamation (or deletion) of objects which were allocated by their classes and which are now being reclaimed (or deleted) by the garbage collection functions.

Accordingly, the garbage collection function(s) of the JVM are modified in one of two ways. In a first arrangement, the garbage collection functions are modified so that upon each marking phase of a garbage collection cycle, a statistical count value is maintained and/or updated for each application program record of the number and/or sizes of live objects encountered (marked) during that garbage collection cycle.

In a second arrangement, the garbage collection functions are modified so that upon each marking phase of a garbage collection cycle, a statistical count value is maintained and/or updated for each application domain of the number and/or sizes of objects reclaimed during that garbage collection cycle.

The use of the term “application domain” herein is to be understood to mean an application program comprising one or more application classes, as operating within a JVM capable of operating plural application simultaneously.

The use of the term “application classes” herein is to be understood to mean one or more Java class files and their internal representation within a JVM, that comprise part or all of a single application program.

The use of the term “garbage collection cycle” or “garbage collection event” is to be understood to mean the periodic execution of garbage collection routines or procedures of a JVM directed to identifying Java objects within the computer memory which are no longer used or referenced by “live” objects and which may be reclaimed.

The use of the term “mark phase” is to be understood to mean the garbage collection routines or procedures directed to determining which objects are reachable by “live” references and therefore cannot be reclaimed, and which Objects are not reachable by “live” references and therefore may be reclaimed in due course.

In accordance with a first aspect of the present invention there is disclosed a modified JVM for hosting plural application programs within a single executing instance of said modified JVM, wherein said JVM is modified to maintain in computer memory an application program record for each said application program, and where each said application program comprises one or more application classes, and where for each application program record a first utilisation count of the total memory occupied by all allocated instances of said application classes is maintained in said computer memory.

Preferably for each allocation of a new instance of said application classes, said first utilisation count is incremented with the occupied memory size of said new instance.

Preferably, said first utilisation count is a count of bytes of memory.

Preferably, said occupied memory size is the memory size in bytes occupied by said new instance.

Preferably, said allocated instances include within their memory layout a reserved value identifying said application program record of said application classes.

Preferably, for each allocation of a new instance of said application classes, recording in said reserved value of said new instance, the identity of said application program record.

Alternatively, said application classes include within their memory layout a reserved value identifying said application program record to which they belong.

Preferably during a garbage collection event, recording for each application program record, a second utilisation count of the total memory occupied by all allocated instances of said application classes not reclaimed during garbage collection.

Preferably during or after a garbage collection event, updating said first utilisation count value with said second utilisation count value.

Alternatively, during a garbage collection event, for each application program record updating said first utilization count of the total memory occupied by all allocated instances of said application classes not reclaimed during garbage collection.

The foregoing describes only some embodiments of the present invention and modifications, obvious to those skilled in the computing arts, can be made thereto without departing from the scope of the present invention.

The term “comprising” (and its grammatical variations) as used herein is used in the inclusive sense of “including” or “having” and not in the exclusive sense of “consisting only of”.

APPENDIX A
struct application_program_record (

// The number of bytes allocated for new objects by the application
// classes corresponding to this application_program_record
unsigned int allocated_size;
// The number of bytes of allocated objects reclaimed by the garbage
// collector which were allocated by the application classes
// corresponding to this application_program_record
unsigned int reclaimed_size;

}

APPENDIX B
public org.example.ApplicationClass exampleMethod( ) ;
Code:

| Stack=3, Locals=2, Args_size=1 | |
|---|---|
| 0: aload_0 | |
| 1: getfield | #51; //Field |
| | exampleField:Lorg/example/ApplicationClass |
| 4: ifnull 23 | |
| 7: aload_0 | |
| 8: getfield | #51; //Field |

exampleField.Lorg/example/ApplicationClass

| | |
|---|---|
| 11: invokeinterface | #74, 1; //InterfaceMethod |

org/example/OtherClass.otherMethod ( ) Lorg/example/ApplicationClass

| 16: astore_1 | |
|---|---|
| 17: aload_1 | |
| 18: ifnull 23 | |
| 21: aload_1 | |
| 22: areturn | |
| 23: new | #198; //class org/example/ApplicationClass |

| 26: dup | |
|---|---|
| 27: aload_0 | |
| 28: getfield | #40; //Field otherField:Ljava/lang/Class; |

31: invokespecial#199: //Method

org/example/ApplicationClass “<init>”:(Ljava/lang/Class;)V

34: areturn

1. A modified JVM or a method of modifying a JVM for hosting multiple Java applications within a single executing instance of said modified JVM, wherein said JVM is modified to maintain in computer memory a record of one or more application domains, each said application domain comprising one or more application classes, and wherein for each application domain a first utilisation count of the total memory occupied by all allocated instances of said application classes is maintained in said computer memory.

2. A modified JVM as claimed in claim 1 wherein for each allocation of a new instance of said application classes, said first utilisation count is incremented with the occupied memory size of said new instance.

3. A modified JVM as claimed in claim 1 wherein said first utilisation count is a count of bytes of memory.

4. A modified JVM as claimed in claim 1 wherein said occupied memory size is the memory size in bytes occupied by said new instance.

5. A modified JVM as claimed in claim 1 wherein said allocated instances include within their memory layout a reserved value identifying said application domain of said application classes.

6. A modified JVM as claimed in claim 1 wherein for each allocation of a new instance of said application classes, a record is made in said reserved value of said new instance, of the identity of said application domain.

7. A modified JVM as claimed in claim 1 wherein said application classes include within their memory layout a reserved value identifying said application domain to which they belong.

8. A modified as claimed in claim 1 wherein during a garbage collection event, recording for each application domain, a second utilisation count of the total memory occupied by all allocated instances of said application classes not reclaimed during garbage collection.

9. A modified JVM as claimed in claim 1 wherein during or after a garbage collection event, updating said first utilisation count value with said second utilisation count, value.

10. A modified JVM as claimed in claim 1 wherein during a garbage collection event, for each application domain updating said first utilization count of the total memory occupied by all allocated instances of said application classes not reclaimed during garbage collection.

11. A method of modifying a JVM for hosting multiple Java applications within a single executing instance of said modified JVM, wherein said JVM is modified to maintain in computer memory a record of one or more application domains, each said application domain comprising one or more application classes, and wherein for each application domain a first utilisation count of the total memory occupied by all allocated instances of said application classes is maintained in said computer memory.

12. A method of modifying a JVM as claimed in claim 11 wherein for each allocation of a new instance of said application classes, said first utilisation count is incremented with the occupied memory size of said new instance.

13. A method of modifying a JVM as claimed in claim 11 wherein said first utilisation count is a count of bytes of memory.

14. A method of modifying a JVM as claimed in claim 11 wherein said occupied memory size is the memory size in bytes occupied by said new instance.

15. A method of modifying a JVM as claimed in claim 11 wherein said allocated instances include within their memory layout a reserved value identifying said application domain of said application classes.

16. A method of modifying a JVM as claimed in claim 11 wherein said allocated instances include within their memory layout a reserved value identifying said application domain of said application classes.

17. A method of modifying a JVM as claimed in claim 11 wherein said application classes include within their memory layout a reserved value identifying said application domain to which they belong.

18. A method of modifying a JVM as claimed in claim 11 wherein during a garbage collection event, recording for each application domain, a second utilisation count of the total memory occupied by all allocated instances of said application classes not reclaimed during garbage collection.

19. A method of modifying a JVM as claimed in claim 11 wherein during or after a garbage collection event, updating said first utilisation count value with said second utilisation count value.

20. A method of modifying a JVM as claimed in claim 11 wherein during a garbage collection event, for each application domain updating said first utilization count of the total memory occupied by all allocated instances of said application classes not reclaimed during garbage collection.
